(19) United States
(12) Patent Application Publication
(10) Pub. No.: US 2008/0204346 A1
(43) Pub. Date: Aug. 28, 2008

(54) ANTENNA ADJUSTING METHOD AND ANTENNA DEVICE

(75) Inventor: Masatake Tawata, Ritto-shi (JP)

Correspondence Address: OSHA LIANG L.L.P., 1221 MCKINNEY STREET, SUITE 2800, HOUSTON, TX, 77010, US

(73) Assignee: OMRON CORPORATION, Kyoto-shi (JP)

(21) Appl. No.: 12/035,243

(22) Filed: Feb. 21, 2008

(30) Foreign Application Priority Data
Feb. 22, 2007 (JP) 2007-042034

(51) Int. Cl. H01Q 19/10

(52) U.S. Cl. 343/834

(57) ABSTRACT

An antenna adjusting method is disclosed wherein a frequency characteristic of an antenna device is adjusted by changing a shape of a reflecting conductor in the antenna device. The antenna device includes a radiator, which is formed by a metal or a metal and a dielectric material to radiate an electromagnetic wave, and a plate-shape reflecting conductor which forms a doubled wavelength of the electromagnetic wave by reflecting the electromagnetic wave radiated from the radiator.

### BACKGROUND OF THE INVENTION

1. Field of the Invention

The present invention relates to an antenna adjusting method and an antenna device.

2. Description of the Related Art

Conventionally, there is utilized a compact monopole antenna in which a radiator and a reflecting conductor are disposed on a board. The radiator radiates an electromagnetic wave when the electric power is fed to the radiator. The reflecting conductor acts as a ground reflecting the electromagnetic wave radiated by the radiator, thereby forming a doubled wavelength of the radiated electromagnetic wave. The reflecting conductor is grounded.

For example, Japanese Patent Application Laid-Open Nos. 2006-186969, 7-79113, 5-347509 and 2006-519545 and Japanese Utility Model Application Laid-Open No. 7-14714 disclose a technique of trimming a shape of the radiator to adjust a frequency characteristic of the antenna device. The compact radiator designed in a complicated shape for design specifications is produced in large quantities and supplied as a component. A user assembles the purchased radiator in a board in which the reflecting conductor is provided, and produces a final product by incorporating the assembled board into a digital device or the like.

However, sometimes designed characteristic is not obtained because a conductive chassis or the like of the device into which the antenna device is incorporated has a reverse influence on the antenna characteristic. In some cases, the antenna characteristic is changed by a partial design change of a communication device. Because the compact radiator is formed in a mold package, fine adjustment cannot really be performed for individual compact radiator. Additionally, because of increase in cost, it is inefficient to change the design of the radiator to suit user's specification.

### SUMMARY OF THE INVENTION

In accordance with embodiments of the present invention, an antenna adjusting method is provided, wherein a frequency characteristic of an antenna device is adjusted by changing a shape of a reflecting conductor in the antenna device including a radiator which is formed by a metal or a metal and a dielectric material to radiate an electromagnetic wave and a plate-shape reflecting conductor which forms a doubled wavelength of the electromagnetic wave by reflecting the electromagnetic wave radiated from the radiator.

Accordingly, the reflection characteristic of the reflecting conductor can be changed by changing the shape of the reflecting conductor, and the frequency characteristic of the whole antenna device can be adjusted.

In the antenna adjusting method according to one or more embodiments of the present invention, at least two partially-projected projections are provided in the reflecting conductor, because the discontinuous shape of the projection has a large effect on the resonance characteristic, the shape of each projection is dominant in the frequency characteristic of each specific band. Therefore, only the characteristic of the specific band can be changed by changing the shape of one of the projections.

In the antenna adjusting method according to one or more embodiments of the present invention, the projection is linearly projected with a constant width. Accordingly, a trimming amount can be managed by the length of the projection.

In the antenna adjusting method according to one or more embodiments of the present invention, the width of the projection is smaller than one-half the width of the reflecting conductor. Accordingly, because at least the two projections can be formed toward the same orientation, area efficiency is enhanced. Further, when the two projections are projected from the reflecting conductor toward the opposite side of the radiator, the resonance characteristic of each projection may be sharp-pointed.

In the antenna adjusting method according to one or more embodiments of the present invention, plural trimming conductors including conductors separated from one another are provided near the reflecting conductor, and the reflecting conductor is extended by electrically connecting the reflecting conductor and the trimming conductor.

Accordingly, the shape of the reflecting conductor can easily be changed, and the changed shape is easily managed.

In the antenna adjusting method according to one or more embodiments of the present invention, the trimming conductors may be arranged on a straight line. Accordingly, the stepwise change in shape of the reflecting conductor can easily be realized.

In accordance with a first aspect of one or more embodiments of the present invention, an antenna device includes a radiator which is formed by a metal or a metal and a dielectric material to radiate an electromagnetic wave and a plate-shape reflecting conductor which forms a doubled wavelength of the electromagnetic wave by reflecting the electromagnetic wave radiated from the radiator, wherein the reflecting conductor includes at least two partially-projected projections.

Accordingly, because the discontinuous shape of the projection of the reflecting conductor has the large effect on the resonance characteristic, the shape of each projection is dominant in the frequency characteristic of each specific band. Therefore, only the characteristic of the specific band can be changed by changing the shape of one of the projections and the characteristic is easily adjusted.

In accordance with a second aspect of one or more embodiments of the present invention, an antenna device includes a radiator which is formed by a metal or a metal and a dielectric material to radiate an electromagnetic wave and a plate-shape reflecting conductor which forms a doubled wavelength of the electromagnetic wave by reflecting the electromagnetic wave radiated from the radiator, wherein plural trimming conductors including conductors separated from one another are provided near the reflecting conductor.

Accordingly, the reflecting conductor is extended by electrically connecting the reflecting conductor and the trimming conductor, whereby the shape can be changed to adjust the antenna characteristic.

According to one or more embodiments of the present invention, the shape of the reflecting conductor is changed by taking advantage of the imperfect reflection characteristic of the reflecting conductor, so that the antenna characteristic of the antenna device can be adjusted without changing the complicated shape of the radiator.

### BRIEF DESCRIPTION OF THE DRAWINGS

FIG. 1 shows a plan view of an antenna device according to a first embodiment of the present invention;

FIG. 2 shows a graph of a variation in antenna characteristic due to a change in shape of the antenna device of FIG. 1;

FIG. 3 shows a plan view of an antenna device according to a second embodiment of the present invention;

FIG. 4 shows a graph of a variation in antenna characteristic due to a change in shape of the antenna device of FIG. 3;

FIG. 5 shows a plan view of an antenna device according to a third embodiment of the present invention;

FIG. 6 shows a graph of a variation in antenna characteristic due to a change in shape of the antenna device of FIG. 5;

FIG. 7 shows a plan view of an antenna device according to a fourth embodiment of the present invention;

FIG. 8 shows a graph of a variation in antenna characteristic due to a change in shape of the antenna device of FIG. 7;

FIG. 9 shows a plan view of an antenna device according to a fifth embodiment of the present invention;

FIG. 10 shows a graph of a variation in antenna characteristic due to a change in shape of the antenna device of FIG. 9;

FIGS. 11A to 11C show perspective views of a model when the antenna device of FIG. 9 is used;

FIG. 12 shows a graph of an antenna characteristic of the antenna device of FIG. 11;

FIG. 13 shows a plan view of an antenna device according to a sixth embodiment of the present invention;

FIG. 14 shows a plan view of an antenna device according to a seventh embodiment of the present invention;

FIG. 15 shows a plan view of an antenna device according to an eighth embodiment of the present invention;

FIG. 16 shows a plan view of an antenna device according to a ninth embodiment of the present invention;

FIG. 17 shows a perspective view of an antenna device according to a tenth embodiment of the present invention;

FIG. 18 shows a perspective view of an adjustment example of the antenna device of FIG. 1;

FIG. 19 shows a plan view of an antenna device according to an eleventh embodiment of the present invention;

FIG. 20 shows a plan view of an antenna device according to a twelfth embodiment of the present invention; and

FIG. 21 shows a plan view of an antenna device according to a thirteenth embodiment of the present invention.

### DETAILED DESCRIPTION

Embodiments of the present invention will be described with reference to the drawings. FIG. 1 shows an antenna device 1 according to a first embodiment of the present invention. The antenna device 1 includes a radiator 3 molded in a surface of a board 2 and a reflecting conductor 4 formed by a metal layer. When an input electric power is applied to a power feeding portion 5, the radiator 3 radiates an electromagnetic wave. The reflecting conductor 4 acts as a ground reflecting the electromagnetic wave radiated by the radiator 3 in a mirror-reflection manner, thereby forming a doubled wavelength of the radiated electromagnetic wave.

However, unlike an ideal ground, because the reflecting conductor 4 has a finite size, a reflection characteristic of the electromagnetic wave depends on a frequency due to resonance or the like. Therefore, the reflecting conductor 4 cannot correctly perform the mirror reflection of the electromagnetic wave radiated by the radiator 3, and the output of the antenna device 1 is changed by the frequency.

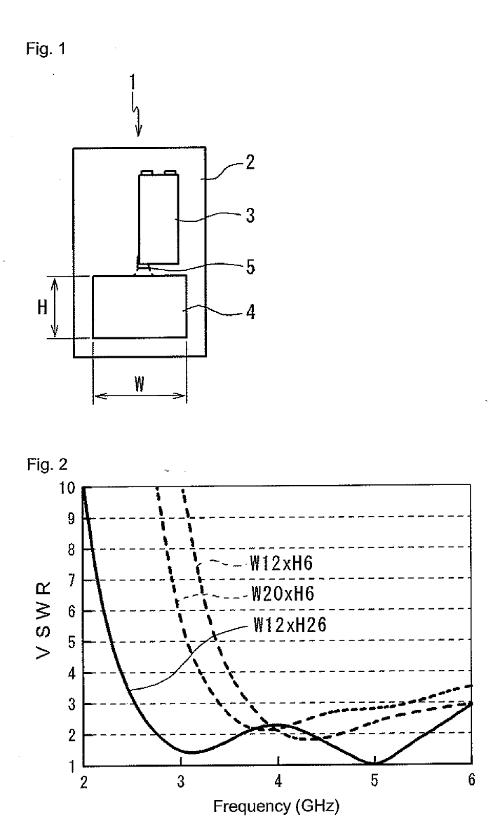

FIG. 2 shows a variation in frequency characteristic of the antenna device 1 when a width W and a height H of the reflecting conductor 4 are changed. The graph of FIG. 2 shows a change in VSWR (voltage standing wave ratio) associated with the frequency. As can be seen from FIG. 2, the frequency characteristic of the antenna device 1 can be changed by changing the shape of the reflecting conductor 4. It can be estimated that the antenna device 1 has a preferable characteristic as the antenna in a frequency band in which VSWR is not more than 2.

However, a correlation cannot be found between a width W or a height H of the reflecting conductor 4 and the frequency characteristic, and it is necessary that the shape of the reflecting conductor 4 be determined by trial and error to obtain the desired frequency characteristic.

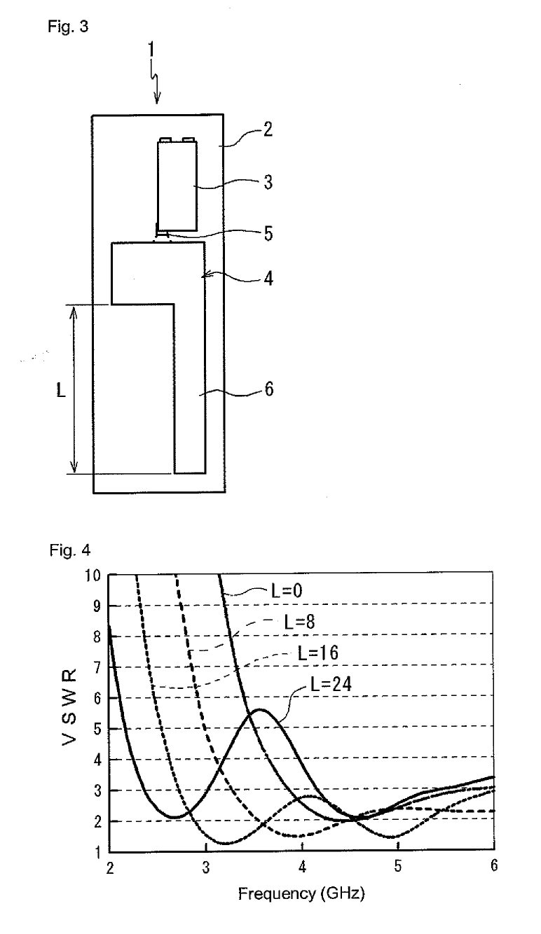

FIG. 3 shows the antenna device 1 according to a second embodiment of the present invention. In the following embodiments, the same component as that of the first embodiment is designated by the same numeral, and the description is omitted. In the antenna device 1 of the second embodiment, the reflecting conductor 4 includes a projection 6 located on an opposite side of a radiator 3, and the projection 6 is linearly projected with a constant width.

FIG. 4 shows a variation in frequency characteristic when a length L of the projection 6 is changed in the second embodiment. As shown in FIG. 4, the frequency characteristic of the antenna device 1 is also changed by changing the length of the projection 6.

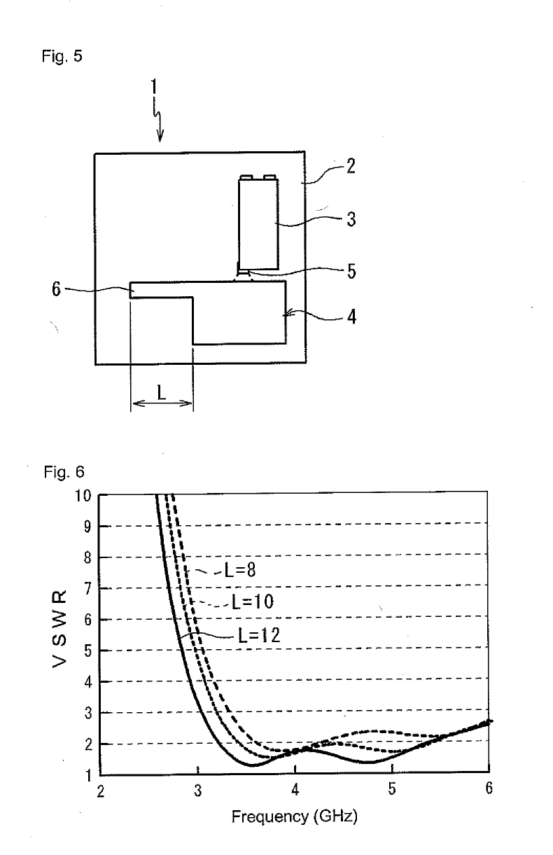

FIG. 5 shows the antenna device 1 according to a third embodiment of the present invention. A projection 6 of the third embodiment is projected toward a horizontal direction from a reflecting conductor 4. FIG. 6 shows a variation in frequency characteristic when the length L of the projection 6 of the antenna device 1 is changed. In the third embodiment, similarly to the second embodiment, the frequency characteristic is also changed by changing the length L of the projection 6.

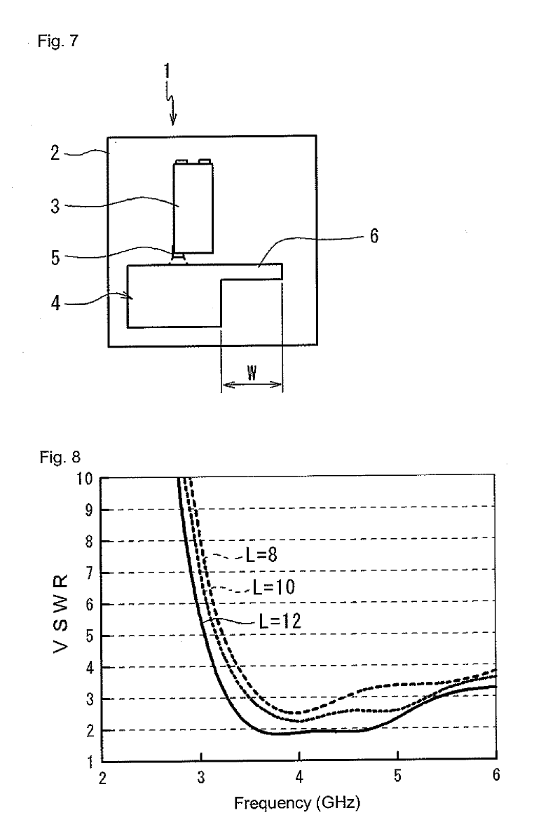

FIG. 7 shows the antenna device 1 according to a fourth embodiment of the present invention. While the projection 6 of the third embodiment is projected from the reflecting conductor 4 toward the left side of the antenna device 1, the projection 6 of the fourth embodiment is formed so as to be projected toward the right side of the antenna device 1. In the fourth embodiment, similarly to the second and third embodiments, the frequency characteristic is also changed by changing the length L of the projection 6 as shown in FIG. 8.

In the variation in antenna characteristic associated with the length of the projection 6 in the embodiments shown in FIGS. 3 to 8, when VSWR is improved at a certain frequency band, VSWR is decreased at other frequency bands. Therefore, the change in antenna characteristic in the embodiments shown in FIGS. 3 to 8 is not suitable to the antenna device used in a broadband.

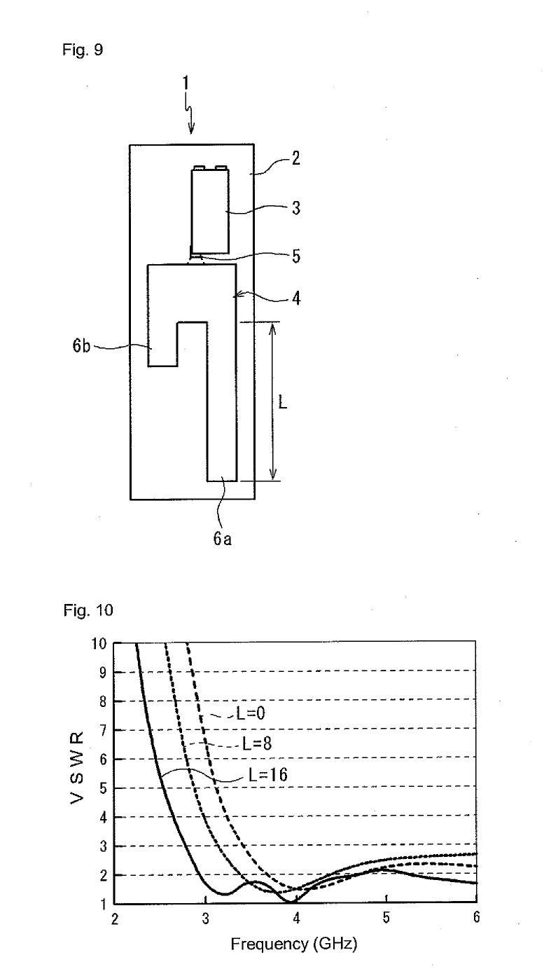

FIG. 9 shows the antenna device 1 according to a fifth embodiment of the present invention, in which the desired antenna characteristic is obtained in the broadband. The antenna device 1 is a UWB antenna used in a band of 3 to 5 GHz, and the antenna device 1 is designed to be incorporated into electronic devices such as a portable terminal. In the fifth embodiment, two projections 6a and 6b are formed in parallel so as to be projected from a reflecting conductor 4 toward the opposite side of a radiator 3.

FIG. 10 shows a variation in frequency characteristic when the length L of the projection 6a is changed in the fifth embodiment. As shown in FIG. 10, in the fifth embodiment, when the length of the projection 6a is increased, the characteristic of the frequency band of 4 GHz or less is largely improved while the length of the projection 6a has little influence on the characteristic of the frequency band of 4 GHz or more.

This is attributed to the fact that a degree of the high-frequency change brought by the change in low-frequency resonance characteristic in which the projection 6a is dominant is reduced because the high-frequency resonance characteristic is retained by the projection 6b.

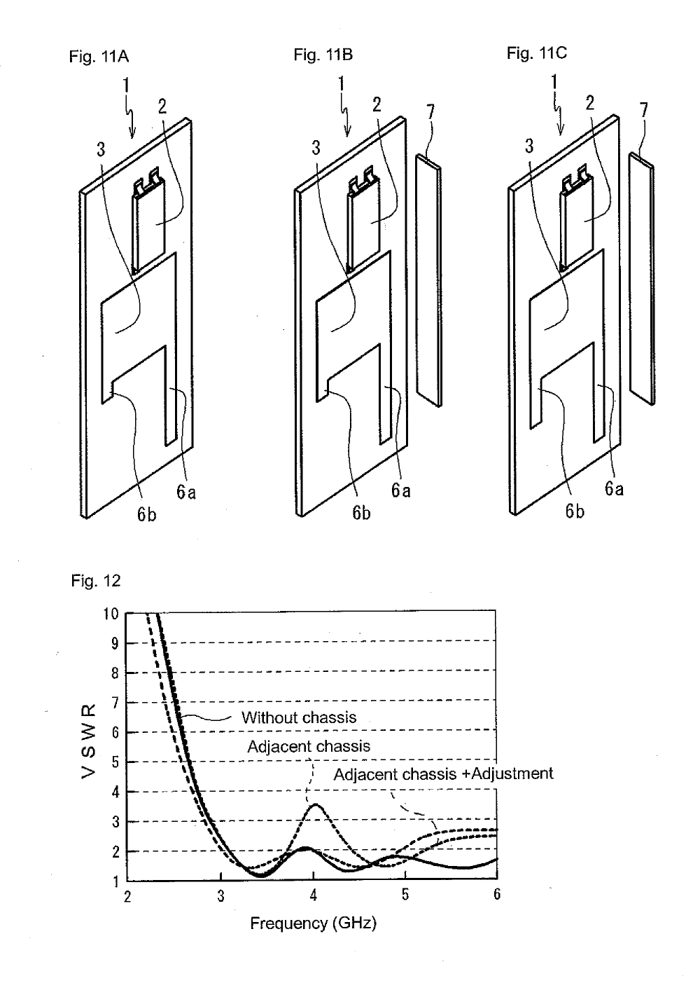

FIGS. 11A to 11C show simulation examples when the antenna device 1 of the fifth embodiment is used. FIG. 11A shows a state of the single antenna device 1, FIG. 11B shows a state in which a metal body 7 used to resemble a chassis is brought close to the antenna device 1, and FIG. 11C shows a state an influence of the metal body 7 is canceled by increasing the length of the projection 6b.

FIG. 12 shows a change in frequency characteristic of the antenna device 1 of FIGS. 11A to 11C. The antenna device 1 is designed to exert VSWR of 2 or less in the frequency band of 3 to 5 GHz in a state shown in FIG. 11A. However, when the metal body 7 is disposed while brought close to the antenna device 1 as shown in FIG. 11B, VSWR is increased around 4 GHz and performance is decreased in the band.

Therefore, as shown in FIG. 11C, when the projection 6b is extended, VSWR can be maintained at a low level in the ranges shorter and longer than around 4 GHz while decreased around 4 GHz.

In the antenna device 1 of the fifth embodiment, the frequency characteristic of the 3-GHz band largely depends on the projection 6a, and the frequency characteristic of the 4-GHz band largely depends on the projection 6b. Therefore, the adjustment can be performed while the antenna characteristic of one of the frequency bands has the little influence on the antenna characteristic of the other frequency band.

The frequency characteristic of the antenna device 1 of the fifth embodiment has the correlation with an outer peripheral distance of the reflecting conductor from the power feeding portion 5 to front ends of the projections 6a and 6b. That is, there is a high concordance rate between the outer peripheral distance of the reflecting conductor 4 from the power feeding portion 5 to front ends of the projections 6a and 6b and the wavelength (inverse number of frequency) showing the low VSWR.

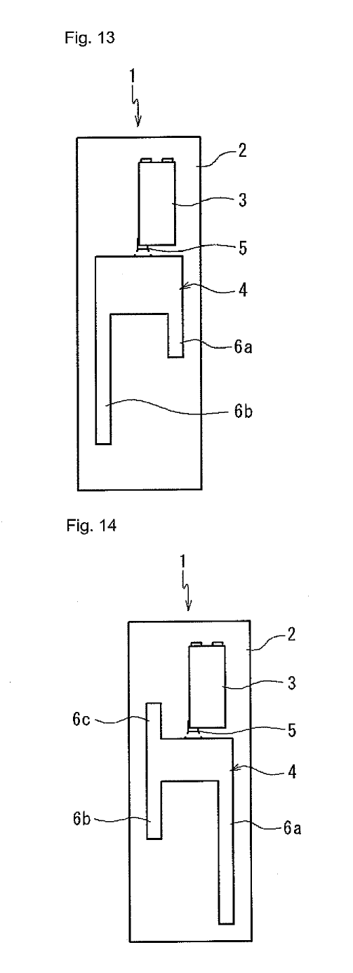

Like the antenna device 1 of a sixth embodiment shown in FIG. 13, this means that the relationship between the lengths of the projection 6a and 6b can be inversed compared with the fifth embodiment.

Like the antenna device 1 of a seventh embodiment shown in FIG. 14, a projection 6c may further be provided while projected from the reflecting conductor 4 toward the same side as the radiator 3.

However, in the projection 6, the characteristic change is easily obtained in the narrower band when the projection 6 is projected toward the opposite side of the radiator 3. This is attributed to the fact that a leading edge of the projection 6 is located on the opposite side of the power feeding portion 5 to make the resonance characteristic sharp-pointed.

Therefore, in the present invention, at least the two projections 6a and 6b are formed in parallel while projected from the reflecting conductor 4 toward the opposite side of the radiator 3. In order to dispose the two projections 6a and 6b in parallel, it is necessary that the width of projection 6 be smaller than one-half the width of the reflecting conductor.

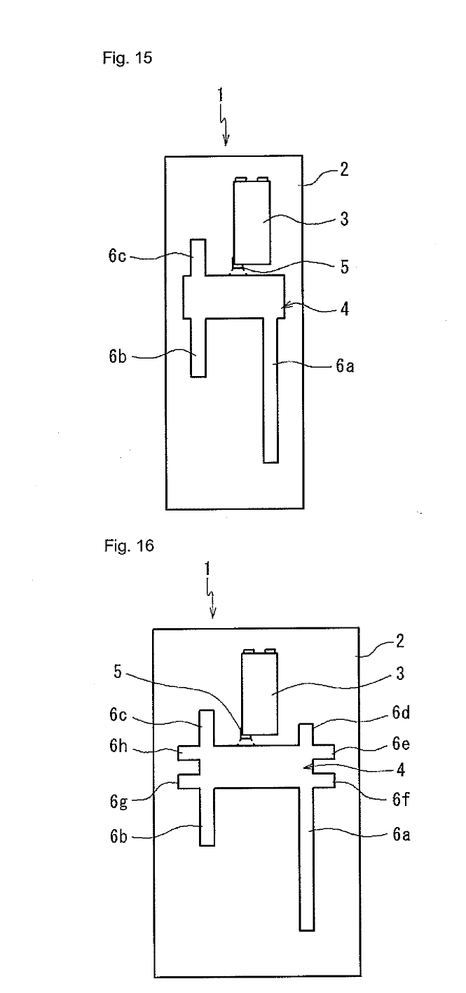

Like the antenna device 1 of an eighth embodiment shown in FIG. 15, projections 6a, 6b, and 6c are not projected from the corner of the reflecting conductor 3, but the projections 6a, 6b, and 6c may be projected from the midpoint of each side.

Like the antenna device 1 of a ninth embodiment shown in FIG. 16, projections 6a, 6b, 6c, 6d, 6e, 6f, 6g, and 6h may be projected toward vertical and horizontal directions from each side of the reflecting conductor 4.

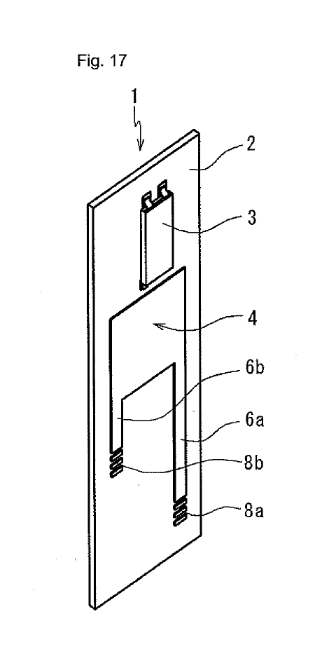

FIG. 17 shows a perspective view of an antenna device 1 according to a tenth embodiment of the present invention. In the antenna device 1, plural trimming conductors 8a and 8b separated from each other are provided in line near extended lines of the projections 6a and 6b respectively.

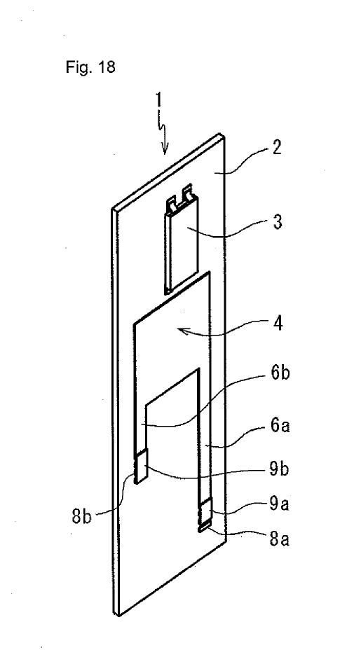

In the tenth embodiment, as shown in FIG. 18, the projections 6a and 6b and the trimming conductors 8a and 8b are electrically connected with metal tapes 9a and 9b. Therefore, the substantial lengths of the projection 6a and 6b can be changed to easily adjust the frequency characteristic of the antenna device.

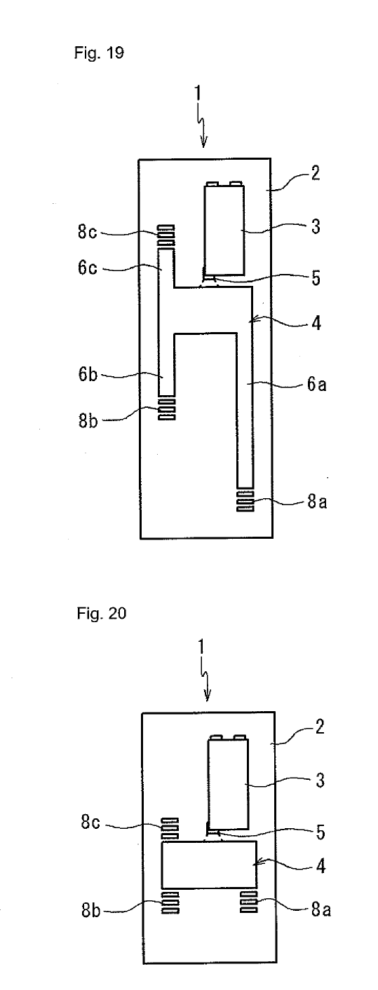

Obviously, like an antenna device 1 of an eleventh embodiment shown in FIG. 19, trimming conductors 8a, 8b, and 8c may be provided near the front ends of the projections 6a, 6b, and 6c. The arrangement, quantity, and size of the trimming conductors 8a, 8b, and 8c can freely be selected.

Like the antenna device 1 of a twelfth embodiment shown in FIG. 20, plural trimming conductors 8a, 8b, and 8c are provided near the main body of the reflecting conductor 4 without providing the projections, and the reflecting conductor 4 and the trimming conductors 8a, 8b, and 8c may be connected to form the resultant projection.

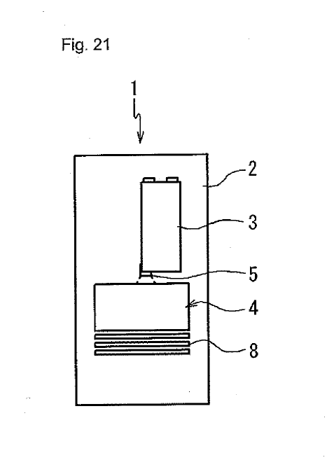

Like the antenna device 1 of a thirteenth embodiment shown in FIG. 21, a trimming conductor 8 having the same width (or height) as the reflecting conductor 4 may be provided near the main body of the reflecting conductor 4 to change the width or height of the reflecting conductor 4.

1. An antenna adjusting method, wherein a frequency characteristic of an antenna device is adjusted by changing a shape of a reflecting conductor in the antenna device including a radiator which is formed by a metal or a metal and a dielectric material to radiate an electromagnetic wave and a plate-shape reflecting conductor which forms a doubled wavelength of the electromagnetic wave by reflecting the electromagnetic wave radiated from the radiator.

2. The antenna adjusting method according to claim 1, wherein the reflecting conductor includes at least two partially-projected projections, and
a shape of the reflecting conductor is changed by changing a length of the projection.

3. The antenna adjusting method according to claim 2, wherein the projection is linearly projected with a constant width.

4. The antenna adjusting method according to claim 3, wherein the width of the projection is smaller than one-half the width of the reflecting conductor.

5. The antenna adjusting method according to claim 1, wherein a plurality of trimming conductors including conductors separated from one another is provided near the reflecting conductor, and
the reflecting conductor is extended by electrically connecting the reflecting conductor and the trimming conductor.

6. The antenna adjusting method according to claim 5, wherein the trimming conductors are arranged on a straight line.

7. An antenna device comprising:
a radiator which is formed by a metal or a metal and a dielectric material to radiate an electromagnetic wave; and
a plate-shape reflecting conductor which forms a doubled wavelength of the electromagnetic wave by reflecting the electromagnetic wave radiated from the radiator,
wherein the reflecting conductor includes at least two partially-projected projections.

8. The antenna device according to claim 7, wherein the projection is linearly projected with a constant width.

9. The antenna device according to claim 8, wherein the width of the projection is smaller than one-half the width of the reflecting conductor.

10. The antenna device according to claim 9, wherein at least the two projections are projected in parallel toward an opposite side of the radiator.

11. The antenna device according to claim 7, wherein trimming conductors including conductors separated from one another are provided in a neighborhood on an extended line of the projection.

12. An antenna device comprising:
a radiator which is formed by a metal or a metal and a dielectric material to radiate an electromagnetic wave; and
a plate-shape reflecting conductor which forms a doubled wavelength of the electromagnetic wave by reflecting the electromagnetic wave radiated from the radiator,
wherein a plurality of trimming conductors including conductors separated from one another is provided near the reflecting conductor.

13. The antenna device according to claim 12, wherein the trimming conductors are arranged on a straight line.

14. The antenna adjusting method according to claim 2, wherein a plurality of trimming conductors including conductors separated from one another is provided near the reflecting conductor, and
the reflecting conductor is extended by electrically connecting the reflecting conductor and the trimming conductor.

15. The antenna adjusting method according to claim 3, wherein a plurality of trimming conductors including conductors separated from one another is provided near the reflecting conductor, and
the reflecting conductor is extended by electrically connecting the reflecting conductor and the trimming conductor.

16. The antenna adjusting method according to claim 4, wherein a plurality of trimming conductors including conductors separated from one another is provided near the reflecting conductor, and
the reflecting conductor is extended by electrically connecting the reflecting conductor and the trimming conductor.

17. The antenna device according to claim 8, wherein trimming conductors including conductors separated from one another are provided in a neighborhood on an extended line of the projection.

18. The antenna device according to claim 9, wherein trimming conductors including conductors separated from one another are provided in a neighborhood on an extended line of the projection.

19. The antenna device according to claim 10, wherein trimming conductors including conductors separated from one another are provided in a neighborhood on an extended line of the projection.
